(19) United States
(12) Patent Application Publication
(10) Pub. No.: US 2026/0270185 A1
(43) Pub. Date: Sep. 10, 2026

(54) METHODS, SYSTEMS, AND COMPUTER READABLE MEDIA FOR DETERMINING ONE-WAY FLOW LATENCY OF MULTI-PATH SWITCHING ENVIRONMENT

(71) Applicant: Keysight Technologies, Inc., Santa Rosa, CA (US)

(72) Inventors: Suvendu Mozumdar, Kolkata (IN); Kingshuk Mandal, Kolkata (IN)

(21) Appl. No.: 19/070,492

(22) Filed: Mar. 4, 2025

(51) Int. Cl. H04L 43/50; H04L 43/067; H04L 43/0852

(52) U.S. Cl. CPC H04L 43/50; H04L 43/067; H04L 43/0858

(57) ABSTRACT

A method for determining one-way packet flow latency of a multi-path switching environment includes transmitting test packets associated with a first packet flow from a network test device through a multi-path switching environment to a destination. The method further includes determining a time required to transmit the packets associated with the first packet flow into the multi-path switching environment. The method further includes receiving the packets associated with the first packet flow. The method further includes determining a time required to receive the plurality of packets associated with the first packet flow from the multi-path switching environment. The method further includes determining a one-way flow latency for the first packet flow as a difference between the time required to receive the packets from the multi-path switching environment and the time required to transmit packets into the multi-path switching environment.

### TECHNICAL FIELD

The subject matter described herein relates to measuring flow-based latency in multi-path packet switching environments. More particularly, the subject matter described herein relates to methods, systems, and computer-readable media for determining one-way flow latency of a multi-path switching environment, such as a data center switching environment.

### BACKGROUND

In computer networks, a traffic flow is a collection of packets sent from the same source to the same destination. The packet flow is typically identified by a five-tuple of source IP address, source port, destination IP address, destination port, and transport layer protocol. In data center networks, different packet flows may follow different paths between a source and a destination because of load balancing schemes implemented by data center switches. It is desirable to characterize data center performance in processing packet flows to measure the effectiveness of load balancing schemes. However, while packet-based latency can be measured, there is no standard mechanism to evaluate the latency of the data center switching environment in processing a packet flow.

Accordingly, in light of these and other difficulties, there exists a need for methods, systems, and computer readable media for determining one-way flow latency of a multi-path switching environments, such as data center switching environments.

### SUMMARY

A method for determining one-way packet flow latency of a multi-path switching environment includes transmitting test packets associated with a first packet flow from a network test device through a multi-path switching environment to a destination. The method further includes determining a time required to transmit the packets associated with the first packet flow into the multi-path switching environment. The method further includes receiving the packets associated with the first packet flow. The method further includes determining a time required to receive the plurality of packets associated with the first packet flow from the multi-path switching environment. The method further includes determining a one-way flow latency for the first packet flow as a difference between the time required to receive the packets from the multi-path switching environment and the time required to transmit packets into the multi-path switching environment.

According to another aspect of the subject matter described herein, transmitting the plurality of test packets into the multi-path switching environment includes transmitting a plurality of stateless data packets into the multi-path switching environment.

According to another aspect of the subject matter described herein, transmitting the plurality of stateless data packets into the multi-path switching environment includes transmitting a plurality of ethernet data packets with or without a virtual local area network (VLAN) tag having a stateless non-internet protocol (IP) payload into the multi-path switching environment.

According to another aspect of the subject matter described herein, transmitting the plurality of stateless data packets into the multi-path switching environment includes transmitting a plurality of internet protocol version 4 or version 6 (IPv4/v6) data packets into the multi-path switching environment.

According to another aspect of the subject matter described herein, transmitting the plurality of stateless transport layer protocol packets into the multi-path switching environment includes transmitting a plurality of user datagram protocol (UDP) packets into the multi-path switching environment.

According to another aspect of the subject matter described herein, transmitting the plurality of test packets into the multi-path switching environment includes transmitting the plurality of test packets from a source host device emulated by the test device and wherein receiving the plurality of test packets from the multi-path switching environment includes receiving the plurality of test packets by a destination host emulated by the test device or the separate test device.

According to another aspect of the subject matter described herein, determining a time required to transmit the first packet flow into the multi-path switching environment includes recording a time T₁ for transmitting a first test packet of the first packet flow into the multi-path switching environment and a time Tₙ for transmitting a last test packet of the first packet flow into the multi-path switching environment and calculating the time required to transmit the first packet flow into the multi-path switching environment as (Tₙ−T₁).

According to another aspect of the subject matter described herein, determining a time required to receive the first packet flow from the multi-path switching environment includes recording a time T₁′ for receiving the first packet from the multi-path switching environment and a time Tₙ′ for receiving the last packet of the first packet flow from the multi-path switching environment and calculating the time required to receive the first packet flow from the multi-path switching environment as (Tₙ′—T₁′).

According to another aspect of the subject matter described herein, determining the one-way flow latency for the first packet flow includes calculating (Tₙ′−T₁′)−(Tₙ−T₁).

According to another aspect of the subject matter described herein, the method for determining the one-way flow latency of the multi-path switching environment includes varying packet sizes of the test packets in the first packet flow.

According to another aspect of the subject matter described herein, determining the one-way flow latency of the multi-path switching environment includes repeating the transmitting, determining, and receiving for a second packet flow of a different duration that the first packet flow to determine a one-way flow latency for the second packet flow.

According to another aspect of the subject matter described herein, the multi-path switching environment comprises a data center switching environment.

According to another aspect of the subject matter described herein, a system for determining one-way packet flow latency of a multi-path switching environment is provided. The system includes a test device including at least one processor and a memory. The system further includes a source host emulated by the test device for transmitting a plurality of test packets associated with a first packet flow from a network test device through a multi-path switching environment to a destination. The system further includes a destination host emulated by the test device for receiving the plurality of test packets associated with the first packet flow. The system further includes a test controller associated with the test device for determining a time required to transmit the first packet flow into the multi-path switching environment, determining a time required to receive the first packet flow from the multi-path switching environment, and determining a one-way flow latency for the first packet flow as a difference between the time required to receive the first packet flow from the multi-path switching environment and the time required to transmit first packet flow into the multi-path switching environment.

According to another aspect of the subject matter described herein, the plurality of test packets includes a plurality of stateless data packets.

According to another aspect of the subject matter described herein, the plurality of stateless data packets includes a plurality of ethernet data packets with or without a virtual local area network (VLAN) tag having stateless non-internet protocol (IP) payload.

According to another aspect of the subject matter described herein, the plurality of stateless data packets includes a plurality of stateless internet protocol version 4 or version 6 (IPv4/v6) data packets.

According to another aspect of the subject matter described herein, the plurality of stateless transport layer protocol packets includes a plurality of user datagram protocol (UDP) packets.

According to another aspect of the subject matter described herein, the test controller is configured to determine the time required to transmit the first packet flow into the multi-path switching environment by recording a time T₁ for transmitting a first test packet of the first packet flow into the multi-path switching environment and a time Tₙ for transmitting a last test packet of the first packet flow into the multi-path switching environment and calculating the time required to transmit the first packet flow into the multi-path switching environment as (Tₙ−T₁).

According to another aspect of the subject matter described herein, the test controller is configured to determine the time required to receive the first packet flow from the multi-path switching environment by recording a time T₁′ for receiving the first packet from the multi-path switching environment and a time Tₙ′ for receiving the last packet of the first packet flow from the multi-path switching environment and calculating the time required to receive the first packet flow from the multi-path switching environment as (Tₙ′−T₁′). According to another aspect of the subject matter described herein, the test controller is configured to determine the one-way flow latency for the first packet flow by calculating (Tₙ′−T₁′)−(Tₙ−T₁).

According to another aspect of the subject matter described herein, the test controller is configured to vary packet sizes of the test packets in the first packet flow.

According to another aspect of the subject matter described herein, the test device is configured to repeat the transmitting, determining, and receiving for a second packet flow of a different flow duration that the first packet flow to determine a one-way flow latency for the second packet flow.

According to another aspect of the subject matter described herein, a non-transitory computer readable medium having stored thereon executable instructions that when executed by a processor of a computer control the computer to perform steps is provided. The steps include transmitting a plurality of test packets associated with a first packet flow from a network test device through a multi-path switching environment to a destination. The steps further include determining, by the test device, a time required to transmit the first packet flow into the multi-path switching environment. The steps further include receiving, by the test device or by a separate test device functioning as the destination, the plurality of test packets associated with the first packet flow. The steps further include determining, by the test device or the separate test device, a time required to receive the first packet flow from the multi-path switching environment. The steps further include determining a one-way flow latency for the first packet flow as a difference between the time required to receive the first packet flow from the multi-path switching environment and the time required to transmit first packet flow into the multi-path switching environment.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating a data center network with multiple paths between hosts;

FIG. 2 is a network and message flow diagram illustrating a method for determining one-way flow latency of a multi-path switching environment;

FIG. 3 is a block diagram illustrating an exemplary architecture for a test device for determining a one-way flow latency of a multi-path switching environment, such as a data center switching environment; and

FIG. 4 is a flow chart illustrating an exemplary process for determining a one-way flow latency of a multi-path switching environment.

### DETAILED DESCRIPTION

Load balancing mechanisms spread traffic across multiple equal cost paths to achieve maximum throughput and low latency in a multi-path switching network, such as a data center network. In a data center, the traffic can be characterized into two profiles, those which are very short lived (known as mouse flows) and those which last for longer times (known as elephant flows). An ideal load balancing scheme should perform equally well for both types of flows. However, most load balancing schemes do not perform equally well for both types of flows due to network dynamics and inefficiencies in the load balancing schemes. To achieve maximum load balancing efficiency, it is important to characterize the performance of a load balancing scheme for these two types of flows. The subject matter described herein includes flow-level measurements to facilitate assessment of the efficiency of a load balancing scheme across different flow types.

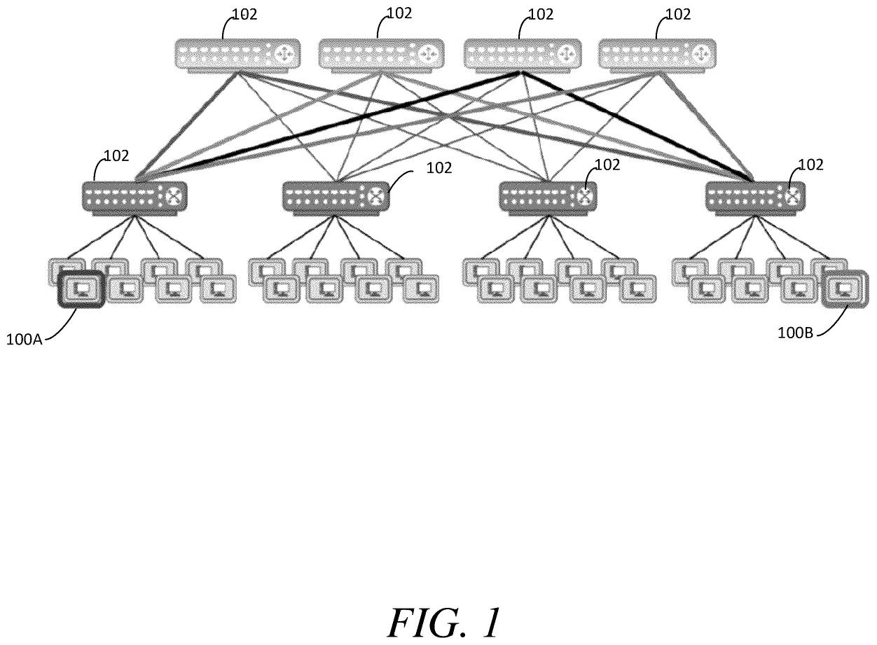

There are multiple load balancing schemes for distributing traffic among multiple equal cost paths between two end hosts. As illustrated in FIG. 1, between a source host 100A and a destination host 100B, there are four paths available through data center switches 102. The most basic load balancing schemes rely on a hashing algorithm based on five-tuples, such as source address, destination address, source port, destination port and protocol. However, in such a scheme, due to hash collisions, multiple long-lived flows can be transmitted through the same port, thereby affecting latency of each flow. In this scheme, a flow is fully bound to a particular transmission port until the end of the flow. To overcome this inefficiency, other load balancing schemes, such as random packet spray (RPS) or flowlet-based load balancing are used. RPS includes randomly transmitting packets associated with a flow through different paths. In flowlet-based load balancing, a particular flow can be sliced into multiple flowlets and distributed across different paths based on the best available resources.

Each load balancing scheme has its advantages and disadvantages, based on not only the dynamic nature of the network, but also the size and duration of a flow. It has been observed in a data center that the north-south flows (i.e., those that travel through different hierarchical levels of switches in the data center switching environment) are typically very short-lived flows whereas the east-west flows (i.e., those that travel across data center switches of the same hierarchical level) last for longer time periods. Hence, it is desirable for a network administrator to understand the efficiency of the load balancing scheme with different types of traffic profile (elephant vs. mouse flows) under different types of network conditions such as link failure, congestion, asymmetricity, etc.

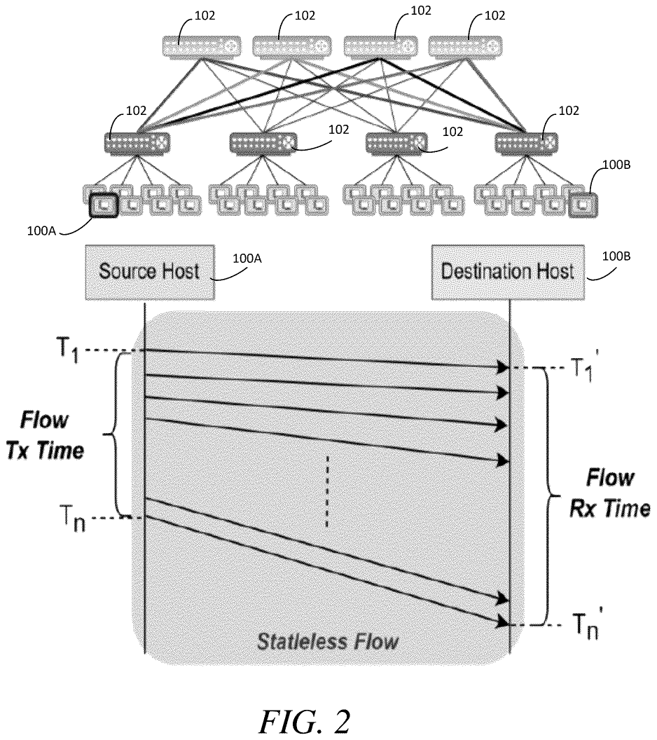

The subject matter described herein includes an efficient method to measure parameters which can provide an analytical view of the efficiency of load balancing mechanism used in a network, such as a data center network. To evaluate the flow level consistency of a load balancing scheme, the subject matter described herein includes a method for measuring the one-way flow latency of a stateless (e.g., user datagram protocol (UDP)) flow between a source-destination pair. Measuring one-way flow latency can be achieved as follows:
1. A network test device emulates a source host that generates a flow destined to a destination host, which, in one example, is also emulated by the network test device.
2. The flow generated by the source host emulated by the network test device is a stateless flow, such as UDP, where the emulated destination host is not required to respond to the packets transmitted by the emulated source host.
3. In FIG. 2, a source host 100A generates a flow which is transmitted for T sec=(Tₙ−T₁). The amount of time and size of data packets required to transmit the flow can be configured and varied by the test administrator.
4. The flow is received by the system under test, as shown by data center switches 102, and forwarded through the four equal cost paths to destination host 100B. The time taken to receive the complete flow at destination host 100B T′ sec=(Tₙ′−T₁′). Ideally, if there is no delay in the system, T′ should be equal to T, but T′ is not equal to T, as the different packets of the flow may take different paths to reach the destination. There will be delay or latency observed, depending on the type of flow (elephant or mouse), network resources, or dynamic changes of the network (link failure, congestion, etc.). The delay (T′−T) is referred to herein as the one-way flow latency normalized over a controlled measurement duration of (Tₙ−T₁). One-way flow latency can be measured for different types of flows, such as elephant and mouse flows, and then compared to assess the efficiency of the load balancing scheme active in the system under test.

Thus, rather than measuring packet latency and using packet latency to characterize a data center load balancing scheme, the subject matter described herein include calculating a flow latency. The flow latency is not a sum of the packet latencies. Rather, the flow latency is a difference between the time required to transmit a packet flow into a data center switching environment and the time required to receive a packet flow from the data center switching environment.

As illustrated in FIG. 1, different packets of the same flow can take different paths through the data center switching environment, depending on the load balancing scheme of the intermediate switches. Also, depending on the size/duration of a flow, the load balancing algorithm may be different. For example, flowlet-based load balancing may not be applied to a mouse flow as the size of the flow may be less than the minimum flow size. Measuring one-way flow latency will help in adjusting network parameters so that an efficient scheme can be achieved, ideally resulting in equal latency for any type of flows. As the test device inserts its own signature and timestamp into each packet, the timings can be measured at the receiving port (i.e., the destination host) and one-way flow latency can be calculated.

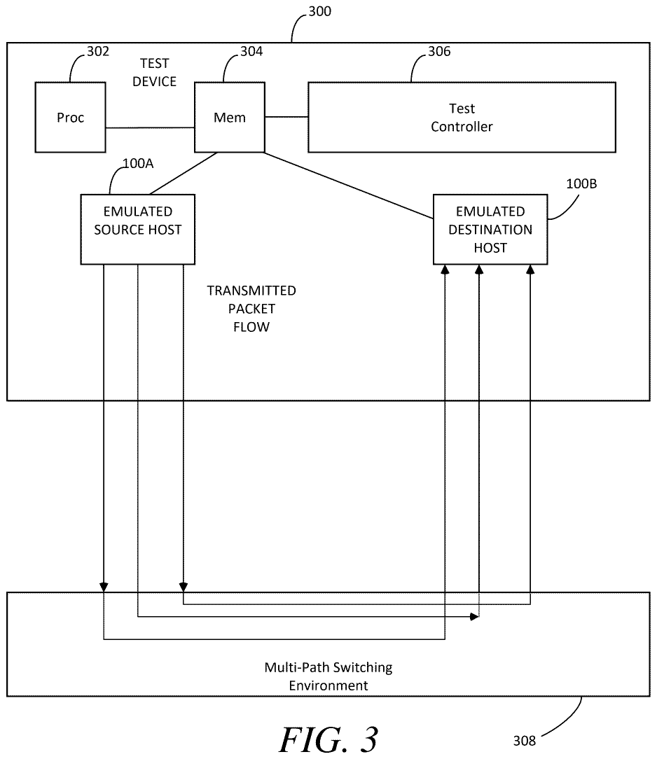

FIG. 3 is a block diagram illustrating an exemplary architecture for a test device for determining a one-way flow latency of a multi-path switching environment, such as a data center switching environment. Referring to FIG. 3, a test device 300 includes at least one processor 302 and memory 304. Test device 300 further includes a test controller 306 that controls the overall operation of test device 300 and calculates the one-way flow latency as described herein. Test device 300 further includes emulated source host 100A and emulated destination host 100B. Emulated source host 100A transmits packets in a packet flow to a multi-path switching environment 308. Emulated destination host 100B receives the packets in the packet flow after being transmitted through the multi-path switching environment and records the time to receive the packets. Test controller 306 calculates the one-way flow latency based on the difference in the time required to transmit the packet flow into multi-path switching environment 308 and the time to receive the packet flow from multi-path switching environment 308. In one example, test controller 306, emulated source host 100A, and emulated destination host 100B may be implemented using computer executable instructions stored in memory 304 and executed by processor 302.

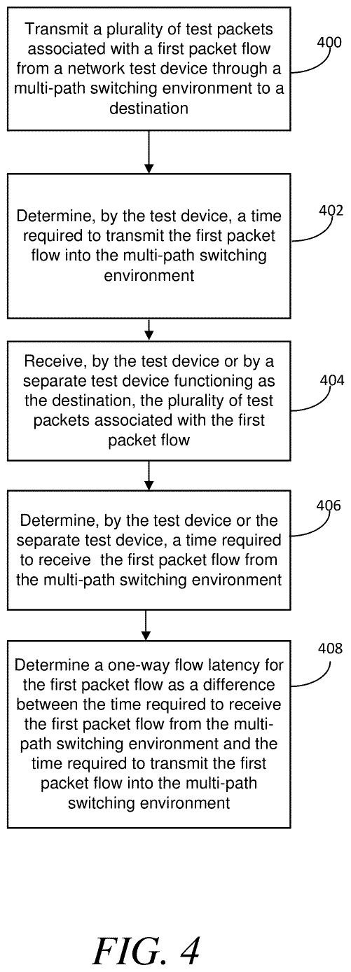

FIG. 4 is a flow chart illustrating an exemplary process for determining one-way flow latency of a multi-path switching environment. Referring to FIG. 4, in step 400, the process includes transmitting a plurality of test packets associated with a first packet flow from a network test device through a multi-path switching environment to a destination. For example, a test device, such as test device 300, may generate a plurality of test packets, which in one example are stateless transport layer protocol packets, such as UDP packets, and transmit the test packets into a data center switching environment. The test packets may be associated with the same packet flow.

In step 402, the process further includes determining, by the test device, a time required to transmit the first packet flow into the multi-path switching environment. For example, a test device, such as test device 300 may determine the time T sec=(Tₙ−T₁). where T₁ is the time when test device 300 transmits the first packet of the packet flow into the data center switching environment through emulated source host 100A and Tₙ is the time when test device 300 transmits the last packet of the packet flow into the data center switching environment through emulated source host 100A.

In step 404, the process further includes receiving, by the test device or by a separate test device functioning as the destination, the plurality of test packets associated with the first packet flow. For example, a test device, such as test device 300 or a separate test device that emulates a receiving host may receive the test packets from the data center switching environment.

In step 406, the process further includes determining, by the test device or the separate test device, a time required to receive the first packet flow from the multi-path switching environment. For example, a test device, such as test device 300 may calculate the time (Tₙ′−T₁′), where T₁′ is the time when test device 300 receives the first packet of the packet flow from the data center switching environment at emulated destination host 100B and Tₙ′ is the time when test device 300 receives the last packet of the packet flow from the data center switching environment at emulated destination host 100B.

In step 408, the process further includes determining a one-way flow latency for the first packet flow as a difference between the time required to receive the first packet flow from the multi-path switching environment and the time required to transmit the first packet flow into the multi-path switching environment. For example, a test device, such as test device 300 may calculate the one-way flow latency as T′−T.

Test device 300 may transmit different packet flows into a data center switching environment, where the different packet flows have different durations and/or different packet sizes and determine the one-way flow latency of the data center switching environment for each of the different packet flows.

The subject matter described herein determines the one-way flow latency instead of determining the one-way packet latencies of individual packets traversing the network. One-way packet latency is the difference between a transmit and receive timestamp of an individual packet. In contrast, the one-way flow latency, as described herein, is calculated without calculating one-way (or two-way) network delays of individual packets. The one-way flow latency is calculated as: (time of receipt of last packet in packet flow minus time of receipt of first packet in packet flow) minus (time of transmission of last packet in packet flow minus time of transmission of first packet in packet flow). Thus, using a flow of data packets of fixed duration transmitted from the transmit side and calculating the receive duration of the same flow on the receive side, one-way flow latency can be determined without calculating network delays of individual packets.

By measuring one-way flow latency, the subject matter described herein provides detailed insight into the flow-level load balancing efficiency of their networks. With stateless traffic, one-way flow latency measures the latency in a single direction and does not include the response time from the receiver, which precisely characterizes the switching latency of data center switches to transmitted traffic. The test device can generate the stateless traffic at line rate with varying packet sizes and measure the one-way flow latency under stress conditions. Changing packet sizes and flow durations of the packet flow facilitates the evaluation of data center load balancing mechanisms under various network conditions.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for determining one-way packet flow latency of a multi-path switching environment, the method comprising:
transmitting a plurality of test packets associated with a first packet flow from a network test device through a multi-path switching environment to a destination;
determining, by the test device, a time required to transmit the first packet flow into the multi-path switching environment;
receiving, by the test device or by a separate test device functioning as the destination, the plurality of test packets associated with the first packet flow;
determining, by the test device or the separate test device, a time required to receive the first packet flow from the multi-path switching environment; and
determining a one-way flow latency for the first packet flow as a difference between the time required to receive the first packet flow from the multi-path switching environment and the time required to transmit the first packet flow into the multi-path switching environment.

2. The method of claim 1 wherein transmitting the plurality of test packets into the multi-path switching environment includes transmitting a plurality of stateless data packets into the multi-path switching environment.

3. The method of claim 2 wherein transmitting the plurality of stateless data packets into the multi-path switching environment includes transmitting a plurality of virtual local area network (VLAN)-tagged ethernet data packets with stateless non-internet protocol (IP) payload or stateless internet protocol version 4 or version 6 (IPv4/v6) data packets or user datagram protocol (UDP) packets into the multi-path switching environment.

4. The method of claim 1 wherein transmitting the plurality of test packets into the multi-path switching environment includes transmitting the plurality of test packets from a source host device emulated by the test device and wherein receiving the plurality of test packets from the multi-path switching environment includes receiving the plurality of test packets by a destination host emulated by the test device or the separate test device.

5. The method of claim 1 wherein determining a time required to transmit the first packet flow into the multi-path switching environment includes recording a time T₁ for transmitting a first test packet of the first packet flow into the multi-path switching environment and a time Tₙ for transmitting a last test packet of the first packet flow into the multi-path switching environment and calculating the time required to transmit the first packet flow into the multi-path switching environment as (Tₙ−T₁).

6. The method of claim 5 wherein determining a time required to receive the first packet flow from the multi-path switching environment includes recording a time T₁′ for receiving the first packet from the multi-path switching environment and a time Tₙ′ for receiving the last packet of the first packet flow from the multi-path switching environment and calculating the time required to receive the first packet flow from the multi-path switching environment as (Tₙ′−T₁′).

7. The method of claim 6 wherein determining the one-way flow latency for the first packet flow includes calculating (Tₙ′−T₁′)−(Tₙ−T₁).

8. The method of claim 1 comprising varying packet sizes of the test packets in the first packet flow.

9. The method of claim 1 comprising repeating the transmitting, determining, and receiving for a second packet flow of a different duration that the first packet flow to determine a one-way flow latency for the second packet flow.

10. A system for determining one-way packet flow latency of a multi-path switching environment, the system comprising:
a test device including at least one processor and a memory;
a source host emulated by the test device for transmitting a plurality of test packets associated with a first packet flow from a network test device through a multi-path switching environment to a destination;
a destination host emulated by the test device for receiving the plurality of test packets associated with the first packet flow; and
a test controller associated with the test device for determining a time required to transmit the first packet flow into the multi-path switching environment, determining a time required to receive the first packet flow from the multi-path switching environment, and determining a one-way flow latency for the first packet flow as a difference between the time required to receive the first packet flow from the multi-path switching environment and the time required to transmit first packet flow into the multi-path switching environment.

11. The system of claim 10 wherein the plurality of test packets includes a plurality of stateless data packets.

12. The system of claim 11 wherein the plurality of test packets includes a plurality of ethernet data packets with or without virtual local area network (VLAN) tag and having stateless non-internet protocol (IP) payload.

13. The system of claim 11 wherein the plurality of test packets includes a plurality of stateless internet protocol (IP) version 4 or 6 (IPv4/v6) data packets.

14. The system of claim 11 wherein the plurality of stateless transport layer protocol packets includes a plurality of user datagram protocol (UDP) packets.

15. The system of claim 10 wherein the test controller is configured to determine the time required to transmit the first packet flow into the multi-path switching environment by recording a time T₁ for transmitting a first test packet of the first packet flow into the multi-path switching environment and a time Tₙ for transmitting a last test packet of the first packet flow into the multi-path switching environment and calculating the time required to transmit the first packet flow into the multi-path switching environment as (Tₙ−T₁).

16. The system of claim 15 wherein the test controller is configured to
determine the time required to receive the first packet flow from the multi-path switching environment by recording a time T₁′ for receiving the first packet from the multi-path switching environment and a time Tₙ′ for receiving the last packet of the first packet flow from the multi-path switching environment and calculating the time required to receive the first packet flow from the multi-path switching environment as (Tₙ′−T₁′).

17. The system of clam 16 wherein the test controller is configured to determine the one-way flow latency for the first packet flow by calculating (Tₙ′−T₁′)−(Tₙ−T₁).

18. The system of claim 10 wherein the test controller is configured to vary packet sizes of the test packets in the first packet flow.

19. The system of claim 10 wherein the test device is configured to repeat the transmitting, determining, and receiving for a second packet flow of a different duration than the first packet flow to determine a one-way flow latency for the second packet flow.

20. A non-transitory computer readable medium having stored thereon executable instructions that when executed by a processor of a computer control the computer to perform steps comprising:
transmitting a plurality of test packets associated with a first packet flow from a network test device through a multi-path switching environment to a destination;
determining, by the test device, a time required to transmit the first packet flow into the multi-path switching environment;
receiving, by the test device or by a separate test device functioning as the destination, the plurality of test packets associated with the first packet flow;
determining, by the test device or the separate test device, a time required to receive the first packet flow from the multi-path switching environment; and
determining a one-way flow latency for the first packet flow as a difference between the time required to receive the first packet flow from the multi-path switching environment and the time required to transmit first packet flow into the multi-path switching environment.
